(19) United States
(12) Patent Application Publication
(10) Pub. No.: US 2012/0200539 A1
(43) Pub. Date: Aug. 9, 2012

(54) DISPLAY DEVICE AND DISPLAY DEVICE DRIVING METHOD

(75) Inventor: Koji Sato, Osaka (JP)

(73) Assignee: SHARP KABUSHIKI KAISHA, Osaka (JP)

(21) Appl. No.: 13/503,323

(22) PCT Filed: May 27, 2010
(86) PCT No.: PCT/JP2010/059021

§ 371 Date: Apr. 26, 2012

(30) Foreign Application Priority Data
Oct. 22, 2009 (JP) 2009-243293

(51) Int. Cl. G06F 3/042; G09G 3/36

(52) U.S. Cl. 345/175; 345/104

(57) ABSTRACT

Disclosed is a liquid crystal display device (30) including a liquid crystal display panel (1) equipped with a light sensor circuit (2) that has a light-receiving element to determine an intensity of light projected on the light-receiving element, and also equipped with a touch detection circuit (3) that detects a touch on a display surface (1a) of the liquid crystal display panel (1) through a displacement of the display surface (1a) in the direction of the thickness of the liquid crystal display panel (1), caused by the touch on the liquid crystal display panel (1). A position vector (6) of the detection object (5) is displayed on the display surface (1a) of the liquid crystal display panel (1) based on the positional data of the detection object (5) obtained from the light sensor circuit (2), and an input operation (image display) corresponding to the position vector (6) of the detection object (5) displayed on the display surface (1a) of the liquid crystal display panel (1) is conducted when a touch on the display surface (1a) of the liquid crystal display panel (1) is detected by the touch detection circuit (3). Thus, the liquid crystal display device having the light sensor function and the touch panel function allows a versatile data entry operation.

### TECHNICAL FIELD

The present invention relates to a display device equipped with a light sensor circuit and a touch detection circuit, and to a method for driving the display device.

### BACKGROUND ART

Display devices with a built-in touch panel (touch sensor) that allows data entry without the use of a data input device such as a keyboard or a mouse have already been developed. In the case of those display devices, data entry is conventionally conducted through menu selection or entry of characters by touching the display of the display device with a finger or other item such as a stylus pen.

Such display devices with a built-in touch panel have been in wide use in multifunctional electronic devices such as PDAs (Personal Digital Assistant), MP3 players, and car navigation systems.

Conventional display devices with a built-in touch panel are typically configured such that a resistive touch panel (the system in which the location of a data entry is determined by the detection of a change in resistance that occurs when the upper conductive substrate comes in contact with the lower conductive substrate at the location of a touch) or a capacitive touch panel (the system in which the location of a data entry is determined by the detection of a change in capacitance that occurs at the location of a touch) is layered over the display surface of a display device such as a liquid crystal display device.

However, the configuration discussed above, in which the resistive touch panel or the capacitive touch panel is layered over the display surface of the display device, has a problem that it causes reduced luminance, increased thickness, and higher production cost of the display device.

Therefore, a configuration in which the resistive touch panel function or the capacitive touch panel function is built into the display device has also been developed.

An example of known such liquid crystal touch panels is configured such that a liquid crystal composition is held between the upper and lower substrates with respective electrodes provided thereon to constitute a liquid crystal display layer, where the liquid crystal composition stays in the cholesteric phase at a room temperature and maintains the display without any electrical field applied to it. Such a liquid crystal display layer is composed of a number of pixels arranged in a matrix, and the electrodes provided on the upper and lower substrates are matrix-driven to display desired images. Also, the above-mentioned liquid crystal composition has an electrical capacity corresponding to the thickness of the liquid crystal layer. When the upper substrate is touched by a finger or the like, the electrical capacity of the touched pixels changes. Consequently, the location of the touch can be determined by detecting the electrical capacity through the above-mentioned electrodes.

In a configuration in which the function of the resistive touch panel or the capacitive touch panel is incorporated into the display device, the presence of a touch is detected by the displacement of the display of the display device in the direction of the thickness, which is caused when a user touches the display with an input means such as a finger or a stylus pen.

However, in the case of the liquid crystal display panel, which is a commonly used display means of the display devices, the two substrates included in the liquid crystal display panel are bonded together with a sealing member provided along the border. As a result, even if a user touches the display of the liquid crystal display panel with the same level of pressure, the degree of displacement of the display at the location of the touch is different between the central region of the liquid crystal display panel where the sealing member is not provided, and the region near the border of the liquid crystal display panel where the sealing member is provided.

The problem is that such variation in the displacement causes inconsistency in the contact resistance of the contact film in the resistive touch panel system, and also causes inconsistency in the capacitance in the capacitive touch panel system, resulting in less accurate determination of the location of a touch.

Meanwhile, also developed in recent years are display devices including light sensors such as photodiodes and phototransistors, which change the current flow according to the amount of the received light, in pixels in the display region.

A display device equipped with the above-mentioned light sensor can suitably be used as a scanner, in which an object such as a piece of paper, for example, is placed on the display of the display device and is scanned so that the image on the paper is captured. However, if it is used to optically determine the location of a touch by a finger, a stylus pen, or the like on the display, or to optically determine if a finger, a stylus pen, or the like is touching or not the display using the shadow or the reflection of the light, either the location of the touch or whether the display is actually touched cannot be determined accurately, because the finger, stylus pen, or the like cast a shadow when it is close enough to the display. Another problem is that the external light is likely to cause operation errors. Further, in the case of the display device equipped only with the light sensors, users cannot get a feeling of touching and directly applying pressure to the display.

In consideration of the problems of display devices equipped only with the light sensors, display devices having the resistive touch panel function or the capacitive touch panel function as well as the light sensor function have also been developed.

For example, in Patent Document 1, a display device including a touch panel and a light sensor disposed under the touch panel is disclosed.

As shown in FIG. 13, a display device 800 includes a touch panel 100, a display panel 200 having a light sensor 700, and a panel driver section 600.

The touch panel 100 includes a first panel 110, a second panel 120 facing the first panel 110, and a light pen 130. When a prescribed pressure is applied to the surface of the touch panel 100, the enable signal is outputted to the panel driver section 600.

On the other hand, the display panel 200 of the display device 800 is equipped with the light sensor 700. From the light sensor 700, the electrical signal corresponding to the positional data of the light pen 130 is sent to the data driver section of the panel driver section 600 through an operation section (not shown) as a control signal.

In the configuration described above, the data driver section forms an image corresponding to the control signal on the display panel 200 if an enable signal that activates the control signal is inputted from the touch panel 100 together with the control signal outputted from the operation section.

Thus, because the control signal, which is transmitted from the light sensor 700 to the data driver section of the panel driver section 600 through the operation section, is activated only when a touch is detected on the touch panel 100, faulty operation of the light sensor 700 that can occur when the light pen 130 is placed close to the touch panel 100 can be suppressed.

Patent Document 1 thus states that a display device that operates accurately and provides a pleasant feeling of touch can be provided.

In the description above, the display device 800 of Patent Document 1 is discussed as an example of the display device having a light sensor function and a resistive or capacitive touch panel function, in which a built-in light sensor function and an externally connected touch panel function are provided. However, some display devices include a light sensor function and a touch panel function, both built in the display panel.

### RELATED ART DOCUMENTS

### Patent Documents

Patent Document 1: Japanese Patent Application Laid-Open Publication No. 2008-129574 (published on Jun. 5, 2008)

Patent Document 2: Japanese Patent Application Laid-Open Publication No. 2007-41602 (published on Feb. 15, 2007)

Patent Document 3: Japanese Patent Application Laid-Open Publication No. 2007-122733 (published on May 17, 2007)

### SUMMARY OF THE INVENTION

### Problems to be Solved by the Invention

In the case of the display device 800 disclosed in Patent Document 1, which includes the light sensor function and the touch panel function, the electrical signal corresponding to the positional data of the light pen 130 is sent from the light sensor 700 through the operation section to the data driver section of the panel driver section 600 as the control signal. However, this control signal will not be used unless the enable signal that activates the control signal is inputted from the touch panel 100.

Therefore, in the above-mentioned configuration, the light sensor 700 detects the location touched by the light pen 130 on the touch panel 100, and an image corresponding to that location is formed on the display panel 200.

In the configuration described above, when the touch panel 100 is touched by the light pen 130, a desired location is selected and simultaneously the selected location is confirmed. The image corresponding to the location of the touch is always displayed as is on the display panel 200.

As discussed above, in the configuration disclosed in Patent Document 1, the selection of a desired location and the confirmation of the selected location cannot be separated from each other. Consequently, although the display device has the light sensor function and the touch panel function, it does not allow a versatile data input operation.

FIG. 14 illustrates how the light sensor function and the touch panel function provided in a conventional display device are used.

As illustrated in the figure, in the case of the above-mentioned display device, the scanner software, for which the light sensor function is performed, and the music player software, for which the touch panel function is performed, are generally run in the following manner. First, the scanner software starts, and a card is scanned with the light sensor function so that the image is captured. After the scanner software finishes running, the music player software starts, and with the touch panel function, the coordinates of the location of the touch are determined and the sound corresponding to that location is played from the speaker.

Therefore, the data obtained from the light sensor function is used only by the scanner software, and the data obtained from the touch panel function is used only by the music player software.

That is, because in a conventional display device having a light sensor function and a touch panel function, the data obtained from the light sensor function and the data obtained from the touch panel function were not used together in either software run by the display device, a versatile data entry operation cannot be conducted.

The present invention was devised in consideration of the problems discussed above, and is aiming at providing a display device that has a light sensor function and a touch panel function and that allows a versatile data entry operation, and is also aiming at providing a method for driving the display device.

### Means for Solving the Problems

In order to solve the problems discussed above, a display device of the present invention includes: a light sensor circuit disposed in a display region of a display panel, the light sensor circuit having a light-receiving element to determine an intensity of the light projected on the light-receiving element; and a touch detection circuit disposed in the display region of the display panel, the touch detection circuit detecting a touch on the display surface of the display panel through a displacement of the display surface in the direction of the thickness of the display panel caused by the touch, wherein based on the positional data of a detection object detected by the light sensor circuit, the position vector of the detection object is displayed on the display surface of the display panel, and when the touch detection circuit detects a touch of the detection object on the display surface of the display panel, an input operation corresponding to the position vector of the detection object displayed on the display surface of the display panel is conducted.

In order to solve the problems discussed above, a method for driving a display device of the present invention is a method for driving a display device that includes: a light sensor circuit disposed in the display region of the display panel, the light sensor circuit having a light-receiving element to determine an intensity of light projected on the light-receiving element; and a touch detection circuit that detects a touch on the display surface of the display panel through a displacement of the display surface in the direction of the thickness of the display panel caused by the touch, wherein the position vector of the detection object is displayed on the display surface of the display panel based on the positional data of the detection object obtained from the light sensor circuit, and an input operation corresponding to the position vector of the detection object displayed on the display surface of the display panel is conducted when a touch by the detection object on the display surface of the display panel is detected by the touch detection circuit.

In the case of a conventional display device including a light sensor circuit and a touch detection circuit, the display panel, for example, has a light sensor included in the light sensor circuit, the touch panel has a touch sensor included in the touch detection circuit, and the display panel and the touch panel are layered together.

In such a conventional display device, when a particular location on the touch panel is touched by a detection object such as a light pen or a finger, for example, the image corresponding to the location is displayed as is on the display panel. That is, as described above, when a particular location on the touch panel is touched, a desired location is selected and simultaneously the selected location is confirmed.

Because a desired location is selected and simultaneously the selected location is confirmed in the configuration described above, even though the display device has both the light sensor circuit and the touch detection circuit, it was difficult to conduct a versatile data input operation, such as the mouse style data input operation, in which the mouse cursor is moved based on the data from the light sensor circuit and pressing of the mouse button is confirmed based on the data from the touch detection circuit.

Also, because in a conventional display device having both a light sensor function and a touch panel function, the data obtained from the light sensor function and the data obtained from the touch panel function were not used together by a software run by the display device, a versatile data input operation was difficult to conduct.

On the other hand, in the case of a display device of the present invention, based on the positional data of the detection object obtained from the light sensor circuit, the position vector of the detection object is shown on the display surface of the display panel, and when a touch on the display surface of the display panel is detected by the touch detection circuit, an input operation corresponding to the position vector of the detection object displayed on the display surface of the display panel is conducted.

Specifically, for example, “a position vector of the detection object is displayed on the display surface of the display panel based on the positional data of the detection object obtained from the light sensor circuit” means that a mouse cursor is moved and displayed at the location of the detection object based on the data obtained from the light sensor circuit. “An input operation corresponding to the position vector of the detection object displayed on the display panel when a touch on the display surface of the display panel is detected by the touch detection circuit” means that whether the mouse button has been pressed is determined based on the data from the touch detection circuit, and if it is determined that the mouse button has been pressed, an image corresponding to the location of the mouse cursor displayed on the display surface of the display panel is displayed.

Also, in the configuration described above, the positional data of a detection object obtained from the light sensor circuit, and the data regarding the presence or absence of a touch by the detection object on the display surface of the display panel obtained from the touch detection circuit are used together for the mouse style data input operation.

According to such a configuration, the display device having a light sensor function and a touch panel function, for example, can perform the mouse style data input operation as described above, and a display device that allows a versatile data input operation and a method for driving the display device can be realized.

### Effects of the Invention

Thus, a display device of the present invention includes: a light sensor circuit disposed in the display region of the display panel, the light sensor circuit having a light-receiving element to determine an intensity of light projected on the light-receiving element; a touch detection circuit disposed in the display region of the display panel, the touch detection circuit detecting a touch on the display surface of the display panel through the displacement of the display surface in the direction of the thickness of the display panel, caused by the touch, wherein based on the positional data of a detection object obtained from the light sensor circuit, the position vector of the detection object is displayed on the display surface of the display panel, and when the touch detection circuit detects the touch by the detection object on the display surface of the display panel, an input operation corresponding to the position vector of the detection object displayed on the display surface of the display panel is conducted.

Thus, a method for driving a display device of the present invention is a method for driving a display device that includes: a light sensor circuit disposed in the display region of a display panel, the light sensor circuit having a light-receiving element to determine an intensity of light projected on the light-receiving element; and a touch detection circuit disposed in the display region of the display device, the touch detection circuit detecting a touch of the detection object on the display surface of the display panel through a displacement of the display surface in the direction of the thickness of the display panel, caused by the touch, wherein based on the positional data of a detection object obtained from the light sensor circuit, the position vector of the detection object is displayed on the display surface of the display panel, and when a touch by the detection object on the display surface of the display panel is detected by the touch detection circuit, an input operation corresponding to the position vector of the detection object displayed on the display surface of the display panel is conducted.

The present invention, therefore, provides a display device including the light sensor function and the touch panel function, and a method for driving the display device.

### BRIEF DESCRIPTION OF THE DRAWINGS

FIG. 1 schematically shows the configuration of a liquid crystal display device according to an embodiment of the present invention.

FIG. 2 is a circuit diagram of the display region of the liquid crystal display device shown in FIG. 1.

FIG. 3 is for describing the touch sensor function mode of a liquid crystal display device according to an embodiment of the present invention.

FIG. 4 is a conceptual diagram showing an example of using the light sensor function mode and the touch sensor function mode of a liquid crystal display device according to an embodiment of the present invention to perform a mouse processing.

FIG. 5 is a flowchart that describes a method for driving a liquid crystal display device according to an embodiment of the present invention.

FIG. 6 is for describing how accurately the location of a detection object can be determined by the light sensor. FIG. 6(a) shows a case when the detection object is not touching the display surface of the liquid crystal display panel, and FIG. 6(b) shows a case when the detection object is touching the display surface of the liquid crystal display panel.

FIG. 7 is for describing how accurately the location of a detection object is determined by the touch sensor. FIG. 7(a) shows a case when the detection object is not touching the display surface of the liquid crystal display panel, and FIG. 7(b) shows a case when the detection object is touching the display surface of the liquid crystal display panel.

FIG. 8 is for describing how accurately the location of a detection object is determined by the light sensor and the touch sensor.

FIG. 9 is a conceptual diagram showing an example of using the light sensor function mode and the touch sensor function mode of a liquid crystal display device according to another embodiment of the present invention to perform a mouse processing.

FIG. 10 is a flowchart that describes a method for driving a liquid crystal display device according to another embodiment of the present invention.

FIG. 11 shows an application example of the light sensor function mode and the touch sensor function mode of a liquid crystal display device according to an embodiment of the present invention to perform a task other than the mouse processing.

FIG. 12 shows another application example of the light sensor function mode and the touch sensor function mode of a liquid crystal display device according to an embodiment of the present invention to perform a task other than the mouse processing.

FIG. 13 shows a conventional display device that has a light sensor function and a touch panel function.

FIG. 14 illustrates how a sensor function and a touch panel function are used in a conventional light display device having those functions.

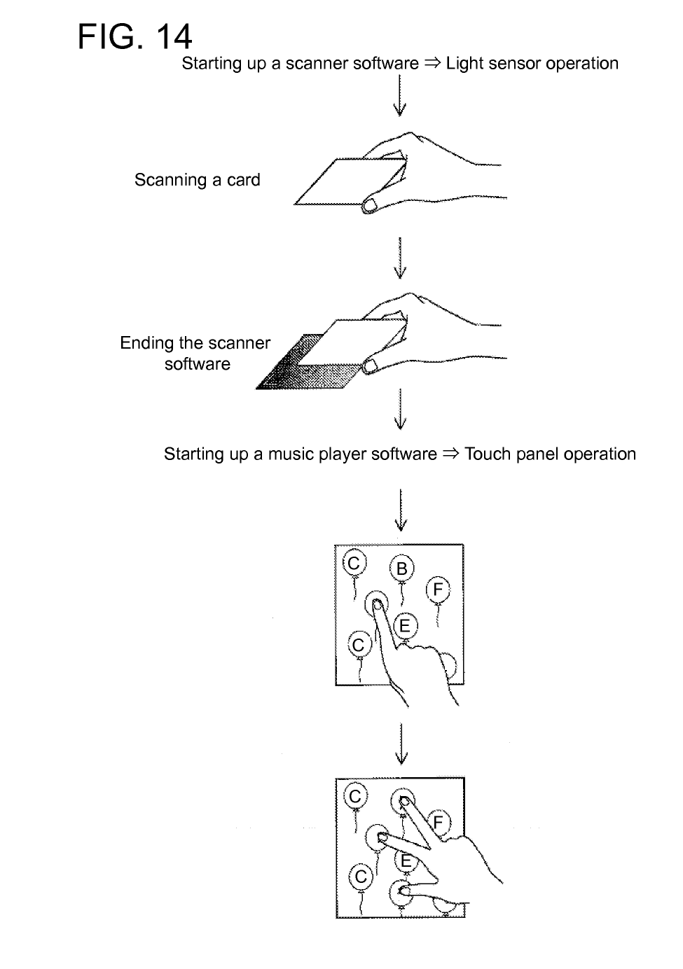

### DETAILED DESCRIPTION OF EMBODIMENTS

Below, embodiments of the present invention are described in detail with reference to figures. It should be noted, however, that the dimensions, materials, shapes, the relative positions of the members constituting these embodiments and the like are merely examples, and they do not in any way limit the scope of the present invention.

### Embodiment 1

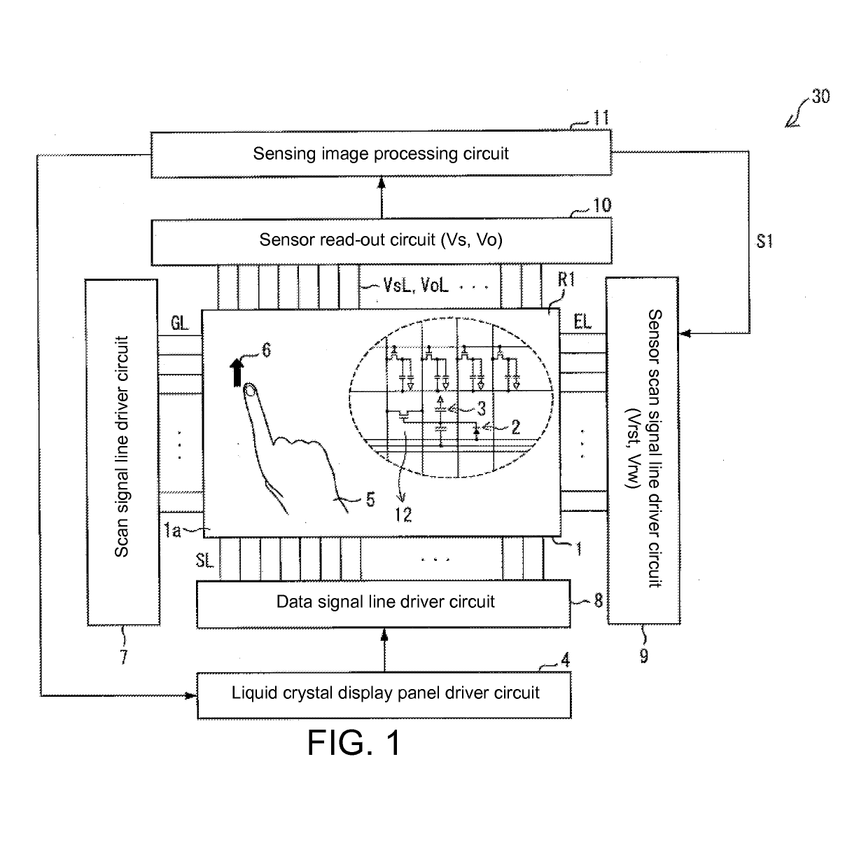

Below, with reference to FIG. 1 to FIG. 6, a liquid crystal display device 30 having a built-in touch panel is described as an example of a display device equipped with a light sensor circuit and a touch detection circuit (touch panel).

FIG. 1 schematically shows the configuration of the liquid crystal display device 30.

As shown in the figure, a liquid crystal display panel 1 (liquid crystal panel) of the liquid crystal display device 30 has a light sensor circuit 2 that includes: a light-receiving element (photodiode) and determines the intensity of the light projected on the light-receiving element; and a touch detection circuit 3 including a capacitance that detects a touch on the display surface 1a of the liquid crystal display panel 1 through a displacement of the display surface 1a in the direction of the thickness of the liquid crystal display panel 1 which is caused by the touch.

That is, the liquid crystal display panel 1 has a sensor circuit 12 including the light sensor circuit 2 and the touch detection circuit 3.

Also, the liquid crystal display device 30 is an active matrix type display device including the liquid crystal display panel 1, a liquid crystal display panel driver circuit 4, a scan signal line driver circuit 7, a data signal line driver circuit 8, a sensor scan signal line driver circuit 9, a sensor read-out circuit 10, and a sensing image processing circuit 11.

The liquid crystal display panel 1 has a plurality of gate wirings GL and a plurality of source wirings SL, which are arranged to intersect one another, and a display region R1 in which pixels disposed for respective intersections of the gate wirings GL and the source wirings SL are arranged in a matrix.

The scan signal line driver circuit 7 sequentially outputs to the individual gate wirings GL the scan signal for selecting the period during which the data signal from the data signal line driver circuit 8 is written.

On the other hand, the data signal line driver circuit 8 outputs to the individual source wiring SL the data signal from the liquid crystal display panel driver circuit 4, which data signal is related to the image to be displayed on the display surface 1a of the liquid crystal display panel 1.

Also, the sensor scan signal line driver circuit 9 sequentially outputs to the individual sensor scan signal lines EL the scan signal (voltage Vrst or voltage Vrw) that operates the sensor circuit 12.

On the other hand, the sensor read-out circuit 10 reads out the sensor output voltage Vo from the individual sensor output wirings VoL, and supplies the power source voltage Vs to the sensor power source wiring VsL.

The sensing image processing circuit 11 analyzes the detection results of the light sensor circuit 2 and the touch detection circuit 3 based on the sensor output voltage Vo, which was read by the sensor read-out circuit 10. Further, the sensing image processing circuit 11 supplies to the sensor scan signal line driver circuit 9 a mode control signal s1 for switching between the light sensor circuit 2 operation and the touch detection circuit 3 operation. This is described in detail below.

Although not shown in FIG. 1, the liquid crystal display device 30 has a power supply circuit, and this power supply circuit supplies power necessary to operate the driver circuits described above.

As shown in FIG. 1, in the present embodiment, the sensor scan signal line driver circuit 9 and the sensor read-out circuit 10 are provided separately from the scan signal line driver circuit 7 and the data signal line driver circuit 8. However, the configuration is not limited to this. Functions of the sensor scan signal line driver circuit 9 and the sensor read-out circuit 10 may be included in the scan signal line driver circuit 7 and the data signal line driver circuit 8.

Also, in the present embodiment, the sensing image processing circuit 11 is provided separately from the sensor read-out circuit 10. However, functions of the sensor read-out circuit 10 and the sensing image processing circuit 11 may be included in either the sensor read-out circuit 10 or the sensing image processing circuit 11.

Also, in the present embodiment, the liquid crystal display panel driver circuit 4, the sensor read-out circuit 10, and the sensing image processing circuit 11 are provided in the liquid crystal display device 30. However, these circuits may be provided outside the liquid crystal display device 30.

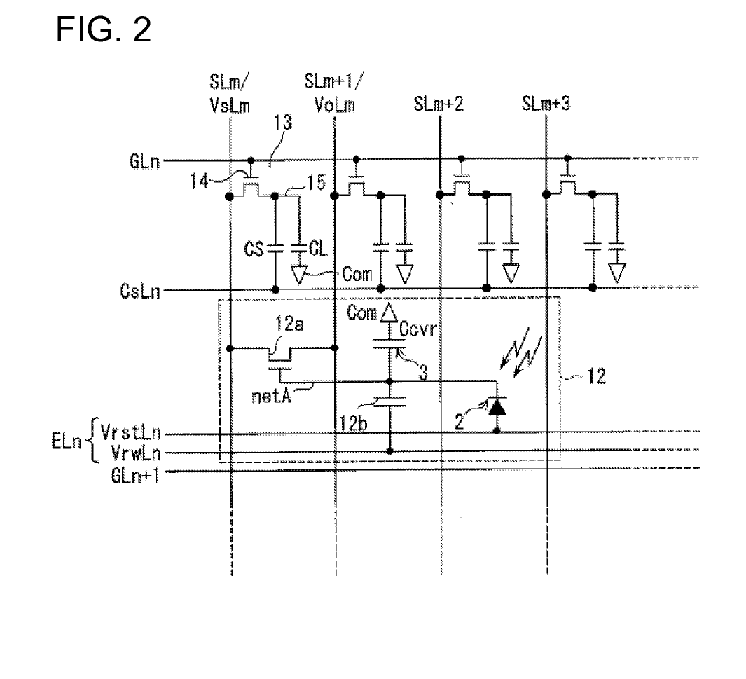

FIG. 2 is a circuit diagram of the display region R1 of the liquid crystal display device 30 shown in FIG. 1.

FIG. 2 shows the configuration of the nth row of the display region R1 of the liquid crystal display device 30. Disposed in the nth row are a gate wiring GLn, source wirings SL (SLm to SLm+3 are shown in the figure), a plurality of pixels 13 defined by the storage capacitance wiring CsLn, a sensor scan signal line ELn composed of a reset wiring VrstLn and a read-out control wiring VrwLn, a sensor power supply wiring VsLm, and a sensor circuit 12 electrically connected to the sensor output wiring VoLm.

The last “n” and “m” of the reference characters denote the row number and the column number, respectively, and the storage capacitance wiring CsLn, the reset wiring VrstLn, and the read-out control wiring VrwLn are disposed in parallel to the gate wiring GLn.

As shown in the figure, each of the pixels 13 includes a TFT element 14, a liquid crystal capacitance CL, and a storage capacitance CS. The gate electrode of the TFT element 14 is electrically connected to the gate wiring GLn, the source electrode is electrically connected to the source wiring SLm, and the drain electrode is electrically connected to the pixel electrode 15. The liquid crystal capacitance CL is formed across the liquid crystal layer disposed between the pixel electrode 15 and the common electrode Com. The storage capacitance CS is formed across the insulating film disposed between the pixel electrode 15 or the drain electrode of the TFT element 14 and the storage capacitance wiring CsLn. To the common electrode Com and the storage capacitance wiring CsLn, a respective prescribed voltage is applied, for example.

As shown in the figure, in the present embodiment, one sensor circuit 12 is provided for every three pixels (each set of RGB pixels, for example). However, the configuration is not limited to this, and any number of sensor circuits 12 may be provided.

The sensor circuit 12 has a light sensor circuit 2 including a TFT element (output amplifier) 12a and a photodiode, a touch detection circuit 3 including a capacitance, and a capacitance 12b.

The gate electrode of the TFT element 12a (input of the output amplifier) is electrically connected to an electrode called node netA, the drain electrode is electrically connected to a source wiring SLm (sensor power supply wiring VsLm), and the source electrode (output of the output amplifier) is electrically connected to another source wiring SLm+1 (sensor output wiring VoLm).

The anode of the photodiode provided in the light sensor circuit 2 is connected to a reset wiring VrstLn, and the cathode is connected to the node netA.

Further, one end of the capacitance 12b is connected to the node netA, and the other end is connected to the read-out control wiring VrwLn. A capacitance is formed across the gate insulating film between the node netA and the read-out control wiring Vrwn.

On the other hand, one end of the capacitance provided in the touch detection circuit 3 is connected to the node netA, and the other end is connected to the common electrode Com. A capacitance having a capacitance value of Ccvr is formed across the liquid crystal layer between the node netA and the common electrode Com.

As described above, the liquid crystal display panel 1 provided in the liquid crystal display device 30 has a photodiode that detects the intensity of the light projected, and a capacitance for detecting a touch on the display surface 1a of the liquid crystal display panel 1 through a displacement of the display surface 1a in the direction of the thickness of the liquid crystal display panel 1, which is caused by the touch on the display surface 1a. Therefore, the liquid crystal display device 30 can conduct both the light sensor function and the touch sensor function (touch panel function).

Below, the light sensor function mode of the liquid crystal display device 30 is described.

In the light sensor function mode, during the period other than the period during which the data signal is written on the pixel 13, the voltage that appears on the node netA according to the intensity of the light projected on the photodiode in the light sensor circuit 2 is outputted from the source electrode of the TFT element 12a as the sensor output voltage Vom and is outputted to the sensor read-out circuit 10, which is outside the display region R1, through the sensor output wiring VoLm (source wiring SLm+1) connected to the source electrode. At this time, the TFT element 12a functions as the source follower, and the sensor output wiring VoLm is electrically cut off from the output of the data signal line driver circuit 8. The source wiring SLm connected to the drain electrode of the TFT element 12a is electrically cut off from the output of the data signal line driver circuit 8 when the light sensor function mode is in operation, and functions as the sensor power supply wiring VsLm, to which a prescribed voltage is applied from the sensor read-out circuit 10.

As shown in FIG. 1 and FIG. 2, in the present embodiment, in consideration of the aperture ratio and the like, the sensor output wiring VoLm doubles as the source wiring SLm, and the sensor power supply wiring VsLm doubles as the source wiring SLm+1. However, the sensor output wiring VoLm and the sensor power supply wiring VsLm may be formed as wirings independent from the source wiring SLm and the source wiring SLm+1, respectively.

Further, when the reset pulse voltage Vrst is applied on the anode of the photodiode in the light sensor circuit 2, the photodiode is forward-biased, and the node netA is brought to a voltage determined by the reset pulse voltage Vrst, the capacitance in the touch detection circuit 3, and the capacitance 12b.

When the period in which the reset pulse voltage Vrst is applied ends, the photodiode in the light sensor circuit 2 is reverse-biased. Then, once a predetermined period has passed, the node netA is brought to the voltage corresponding to the leakage according to the intensity of the light projected on the photodiode.

In such a condition, the read-out pulse voltage Vrwn is applied on one end of the capacitance 12b, and the voltage at the node netA is brought to a level that allows the output from the source electrode of the TFT element 12a. Also, because the TFT element 12a output is obtained while the read-out pulse voltage Vrwn is being applied, the intensity of the light projected on the photodiode can be determined.

As shown in FIG. 1, when a finger, which is a detection object 5, is present on the display surface 1a of the liquid crystal display panel 1, the intensity of the light projected on the photodiode in the light sensor circuit 2 located where the finger is placed becomes lower than the intensity of the light projected on other photodiodes located where the finger is not present. Therefore, the sensing image processing circuit 11 can determine the location of the finger on the display surface 1a of the liquid crystal display panel 1 based on the sensor output voltage Vo read by the sensor read-out circuit 10.

Next, the touch sensor function mode of the liquid crystal display device 30 is described.

The sensor circuit 12 has a capacitance disposed in the touch detection circuit 3. The distance from the common electrode Com, which is the electrode opposite to the node netA of the above-mentioned capacitance, to the electrode on the side of the node netA of the above-mentioned capacitance changes when a user touches the display surface 1a of the liquid crystal display panel 1.

Therefore, the sensor circuit 12 functions as a touch sensor (touch panel), because the sensor circuit 12 can determine whether the display surface 1a of the liquid crystal display panel 1 is touched and the location of the touch by detecting the change in the capacitance value Ccvr of the above-mentioned capacitance, which is caused by the distance change.

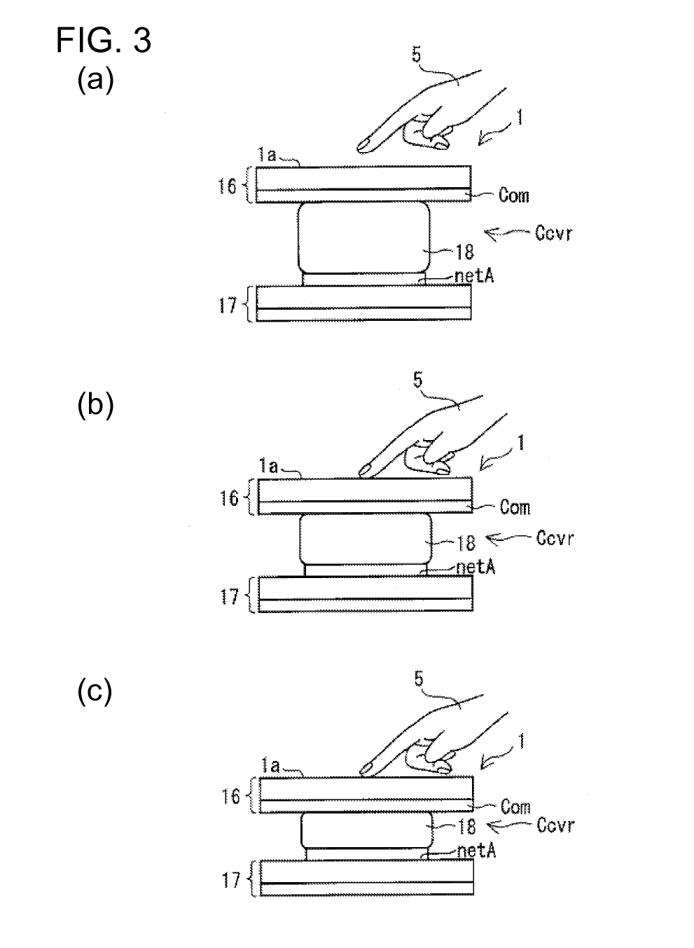

Below, with reference to FIG. 3, the touch sensor function mode of the liquid crystal display device 30 is further described.

FIG. 3(a) is a cross-sectional view showing the liquid crystal display panel 1 when a touch on the display surface 1a of the liquid crystal display panel 1 is not present. The liquid crystal display panel 1 is configured such that a liquid crystal layer 18 is sandwiched between the opposite substrate 16 having the display surface 1a and the TFT substrate 17.

The node netA is provided on the top surface of the TFT substrate 17, and the common electrode Com is provided on the side opposite from the display surface 1a of the opposite substrate 16, forming a capacitance between the node netA and the common electrode Com.

In FIG. 3(a), the opposite substrate 16 is not touched, and therefore the liquid crystal layer 18 sandwiched by the node netA and the common electrode Com is thicker than the liquid crystal layer 18 in FIG. 3(b) or FIG. 3(c) described below. As a result, the capacitance value Ccvr of the above-mentioned capacitance is smaller than that of FIG. 3(b) or FIG. 3(c).

Thus, as illustrated in FIG. 2, the voltage at the node netA is set based on the charge partitioning that is determined by the capacitance 12b having a prescribed capacitance value and the above-mentioned capacitance having a small capacitance value Ccvr.

FIG. 3(b) and FIG. 3(c) are cross-sectional views showing the liquid crystal display panel 1 when a touch is present on the display surface 1a of the liquid crystal display panel 1.

FIG. 3(c) shows the case that the display surface 1a of the liquid crystal display panel 1 is pressed with a greater pressure than in the case shown in FIG. 3(b).

The node netA voltage VnetA is expressed as VnetA=Vinti+(Cst/Ctotal)×ΔVrw, where Vinit is the reset voltage of the node netA before the touch detection is performed, Ctotal is the total capacitance connected to the node netA, and ΔVrw is the change in voltage applied to the read-out control wiring VrwLn.

Here, Ctotal includes Cst (capacitance 12b having a prescribed capacitance value), Ccvr, and other parasitic capacitances.

As the voltage VnetA increases, the sensor output voltage Vo, which is expressed with the voltage of the source electrode of TFT 12a shown in FIG. 2, also increases. Therefore, the higher the aα=Cst/Ctotal becomes, i.e., the lower the Ctotal becomes, the sensor output voltage Vo becomes higher. Here, when the display surface 1a of the liquid crystal display panel 1 is pressed harder, the Ccvr increases and the voltage VnetA decreases accordingly, reducing the sensor output voltage Vo.

Thus, the sensing image processing circuit 11 can determine the presence or absence of a touch and the location of the touch by determining the level of the sensor output voltage Vo read by the sensor read-out circuit 10.

More specifically, when the reset pulse voltage Vrst is applied on the reset wiring VrstLn from the sensor scan signal line driver circuit 9, the photodiode in the light sensor circuit 2 is forward-biased, and the node netA voltage VnetA is reset. At this time, the voltage VnetA is reset approximately to the HIGH level of the reset pulse voltage Vrst.

While the reset pulse voltage Vrst is applied, i.e., while the reset pulse voltage Vrst is at HIGH level, the read-out pulse voltage Vrwn is applied on the read-out control wiring VrwLn from the sensor scan signal line driver circuit 9, and the node netA voltage VnetA rises.

Upon application of the read-out pulse voltage Vrwn, the voltage VnetA rises such that the photodiode of the light sensor circuit 2 is reverse-biased and the output from the source of the TFT 12a becomes possible.

The sensor output voltage Vo outputted from the source of the TFT 12a while the read-out pulse voltage Vrwn is applied becomes the value corresponding to the voltage VnetA, i.e., corresponding to the touch pressure. Therefore, the sensor read-out circuit 10 can read the sensor output voltage Vo through the sensor output wiring Vom and compare the reading with the threshold to determine whether a touch is present or absent.

In the present embodiment, after the read-out pulse voltage Vrwn falls (changes from HIGH level to LOW level), the reset pulse voltage Vrst falls (changes from HIGH level to LOW level), and until the reset pulse voltage Vrst rises the next time (changes from LOW level to HIGH level), the sensor circuit 12 stops its operation.

On the other hand, when the reset pulse voltage Vrst falls, the photodiode disposed in the light sensor circuit 2 is reverse-biased. Consequently, a leakage according to the intensity of the projected light occurs, and the voltage VnetA changes in proportion to the light intensity. However, because the operation period of the touch sensor function mode is set to the period in which the reset pulse voltage Vrst is applied, i.e., the reset pulse voltage Vrst is at HIGH level, and the read-out pulse voltage Vrwn from the sensor scan signal line driver circuit 9 is applied on the read-out control wiring VrwLn, it is possible to prevent the projected light from causing the change in the voltage VnetA and generating a noise in the touch detection operation.

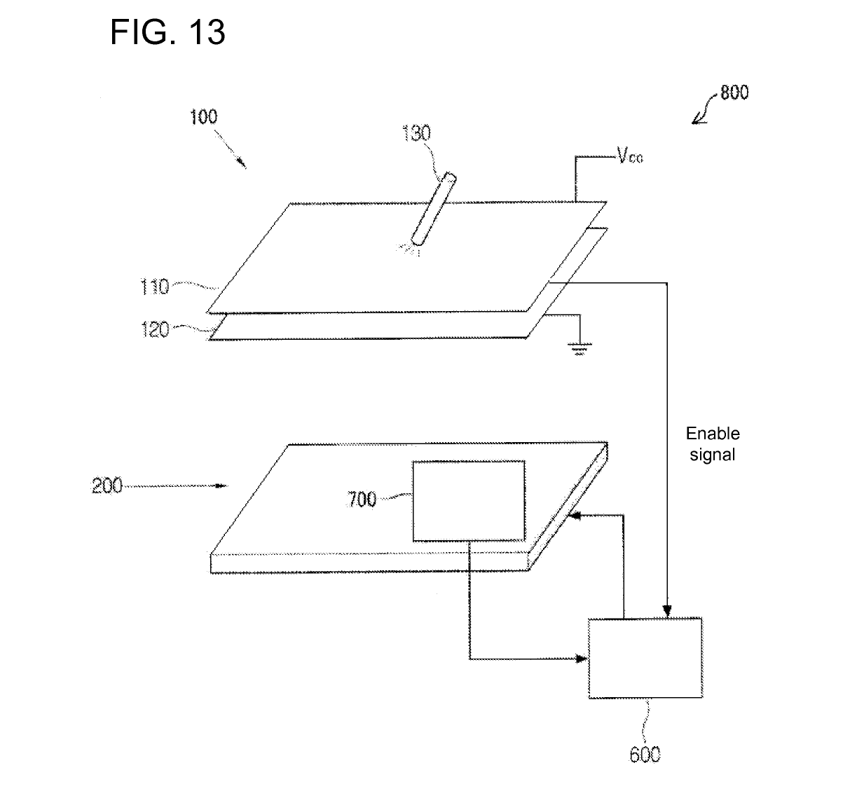

In the present embodiment, the light sensor function mode stops when the operation in the touch sensor function mode is performed, and when the operation in the light sensor function mode is performed, the touch sensor function mode stops. However, the operation is not limited to such. In the configuration in which the touch panel 100, which is a touch sensor, is disposed on the display panel 200 with the light sensor as shown in FIG. 13 provided thereon, for example, the operation in the touch sensor function mode and the operation in the light sensor function mode can also be independently performed.

In the present embodiment, the light sensor function mode and the touch sensor function mode of the liquid crystal display device 30 are switched depending on the time. As shown in FIG. 1, the sensing image processing circuit 11 supplies to the sensor scan signal line driver circuit 9 the mode control signal s1 for switching between the light sensor function mode and the touch sensor function mode at a predetermined time interval. The switching between the light sensor function mode and the touch sensor function mode may be performed by a method other than timing.

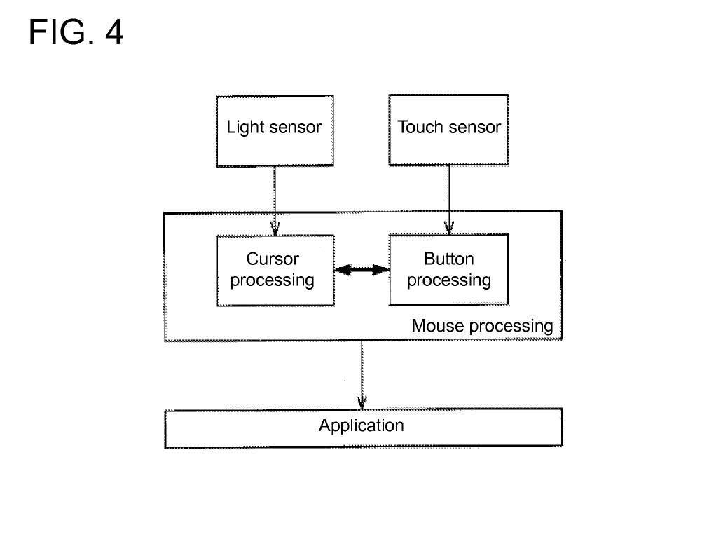

FIG. 4 is a conceptual diagram showing an example of using the light sensor function mode and the touch sensor function mode of the liquid crystal display device 30 to perform a mouse processing.

As shown in the figure, the liquid crystal display device 30, based on the positional data of the detection object 5 (a finger, for example) obtained by the light sensor, the mouse cursor 6 is displayed at a location on the display surface 1a of the liquid crystal display panel 1 corresponding to the location of the detection object 5, as shown in FIG. 1. If the touch sensor detects a touch by the detection object 5 on the display surface 1a of the liquid crystal display panel 1, it is determined that a mouse button processing has occurred, and the image corresponding to the location of the detection object 5 displayed on the display surface 1a of the liquid crystal display panel 1 is displayed.

That is, as shown in FIG. 1, the sensing image processing circuit 11 analyzes the detection result of the light sensor based on the sensor output voltage Vo read by the sensor read-out circuit 10, and the liquid crystal display panel driver circuit 4 displays the mouse cursor 6 at the location corresponding to the location of the detection object 5 based on the analysis result of the sensing image processing circuit 11.

The sensing image processing circuit 11 analyzes the detection result of the touch sensor based on the sensor output voltage Vo read by the sensor read-out circuit 10. The liquid crystal display panel driver circuit 4 displays the image corresponding to the position vector (mouse cursor) 6 of the detection object 5 displayed on the display surface 1a of the liquid crystal display panel 1 based on the analysis result of the sensing image processing circuit 11 regarding the presence or absence of a touch.

With the configuration described above, the liquid crystal display device 30 having the light sensor function and the touch panel function allows a versatile data input operation such as a mouse style data input operation, which was not possible with conventional display devices.

As shown in FIG. 4, in the liquid crystal display device 30, the positional data of the detection object 5 obtained by the light sensor and the data regarding the presence or absence of the detection object 5 on the display surface 1a of the liquid crystal display panel 1 obtained by the touch sensor are used together for the mouse style data input operation (application).

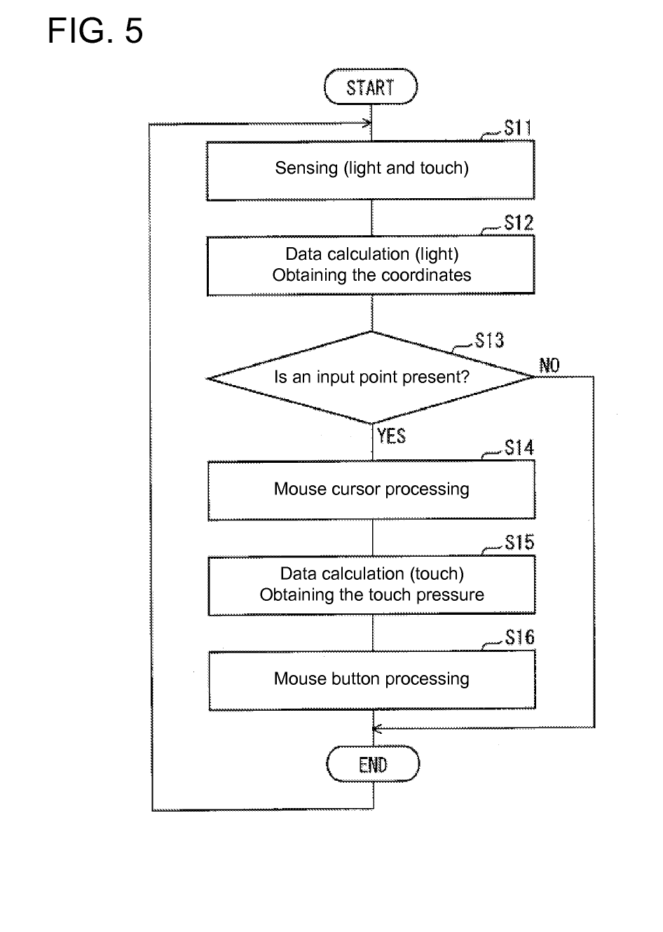

FIG. 5 is a flowchart describing a method for driving the liquid crystal display device 30.

First, in Step S11, sensing is performed by the light sensor and the touch sensor. In Step S12, the data obtained from the light sensor is processed in the sensing image processing circuit 11 to obtain the coordinates. In Step S13, the sensing image processing circuit 11 conducts a calculation for determining whether an input point is present on the display surface 1a of the liquid crystal display panel 1 based on the detection result obtained from the sensor read-out circuit 10. From this calculation result, whether an input point is present or not on the display surface 1a is determined. If an input point is present, the process proceeds to Step S14, and if no input point is present, the process ends. When the process ends, it returns to the first step.

In Step S14, the liquid crystal display panel driver circuit 4 displays the mouse cursor 6 at a location corresponding to the location of the detection object 5 based on the analysis result of the sensing image processing circuit 11.

In Step S15, the data obtained from the touch sensor is processed in the sensing image processing circuit 11 to provide the data regarding the presence or absence of a touch on the display surface 1a of the liquid crystal display panel 1.

In Step S16, the liquid crystal display panel driver circuit 4 displays an image corresponding to the position vector (mouse cursor) 6 of the detection object 5 displayed on the display surface 1a of the liquid crystal display panel 1 based on the analysis result regarding the presence or absence of a touch, obtained from the sensing image processing circuit 11.

Upon completion of Step S16, the process returns to the first step.

In the present embodiment, the position vector of the detection object 5 is indicated by the mouse cursor 6, and the input operation corresponding to the position vector of the detection object 5 displays an image corresponding to the location of the detection object 5. However, the configuration is not limited to such.

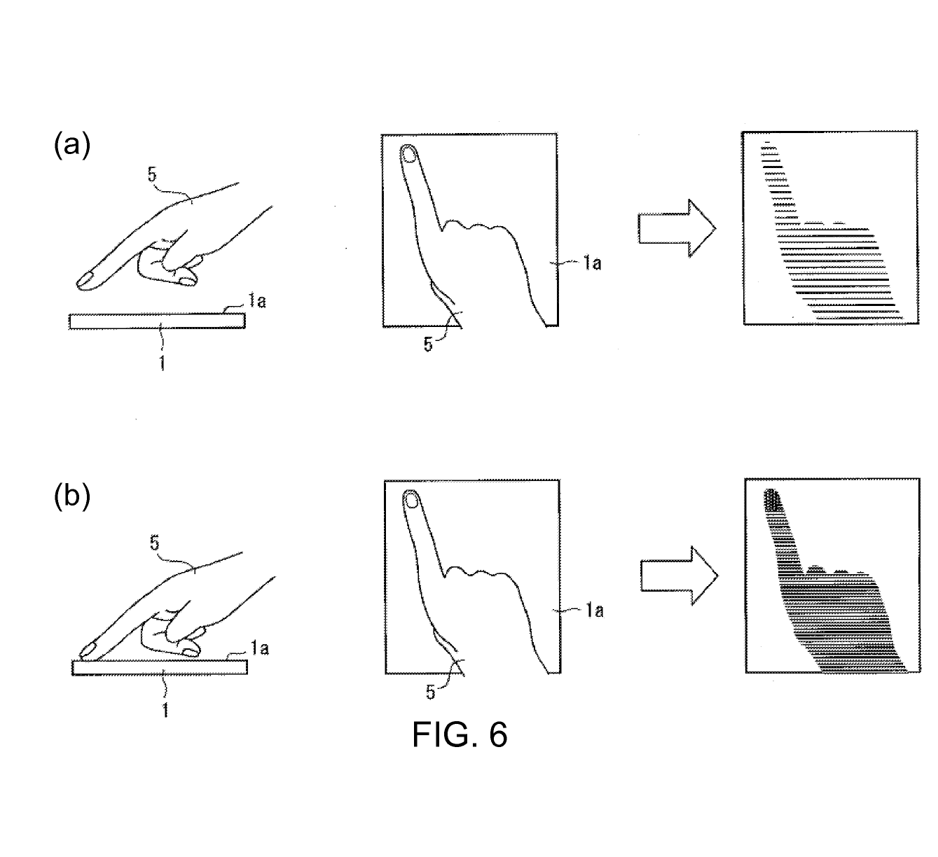

FIG. 6 is for describing how accurately the location of the detection object 5 is determined by the light sensor.

FIG. 6(a) is a sensing image when the detection object 5 is not touching the display surface 1a of the liquid crystal display panel 1, and FIG. 6(b) is a sensing image when the detection object 5 is touching the display surface 1a of the liquid crystal display panel 1.

As shown in FIG. 6(a), when the detection object 5 is not touching the display surface 1a of the liquid crystal display panel 1, the sensing image is based on the shadow of the detection object 5, and it is difficult to determine the location accurately.

On the other hand, as shown in FIG. 6(b), when the detection object 5 is touching the display surface 1a of the liquid crystal display panel 1, the sensing image shows the portion of the detection object 5 that is touching the display surface 1a of the liquid crystal display panel 1 to some extent. As a result, the location can be determined more accurately.

Thus, the liquid crystal display device 30 is preferably configured such that when the touch pressure of the detection object 5 against the display surface 1a of the liquid crystal display panel 1 is equal to or greater than a prescribed value (because, as discussed above, the sensor output voltage Vo changes depending on the touch pressure), an image corresponding to the position vector (mouse cursor) 6 of the detection object 5 displayed on the display surface 1a of the liquid crystal display panel 1 is displayed.

In the configuration described above, only when the touch pressure of the detection object 5 against the display surface 1a is equal to or greater than the prescribed value, that is, only when the detection object 5 touches the display surface 1a with a prescribed pressure or a pressure higher than that, an image corresponding to the position vector (mouse cursor) 6 of the detection object 5 displayed on the display surface 1a of the liquid crystal display panel 1 is displayed.

Therefore, when the detection object 5 touches the display surface 1a with a pressure lower than the prescribed value, the position vector (mouse cursor) 6 of the detection object 5 is displayed on the display surface 1a.

Thus, according to the configuration described above, a mouse cursor, for example, can be moved and displayed when the display surface 1a is touched by the detection object 5 with a light pressure that is lower than the prescribed value. The configuration, therefore, can provide a liquid crystal display device 30 that can determine locations with a higher accuracy and can suppress operation errors such as selection errors.

In the present embodiment, a light sensor and a touch sensor are included in the liquid crystal display panel 1. However, the configuration is not limited to this. Another possible configuration is that a touch panel 100, which is a touch sensor, is disposed on the display panel 200 equipped with a light sensor as shown in FIG. 13.

### Embodiment 2

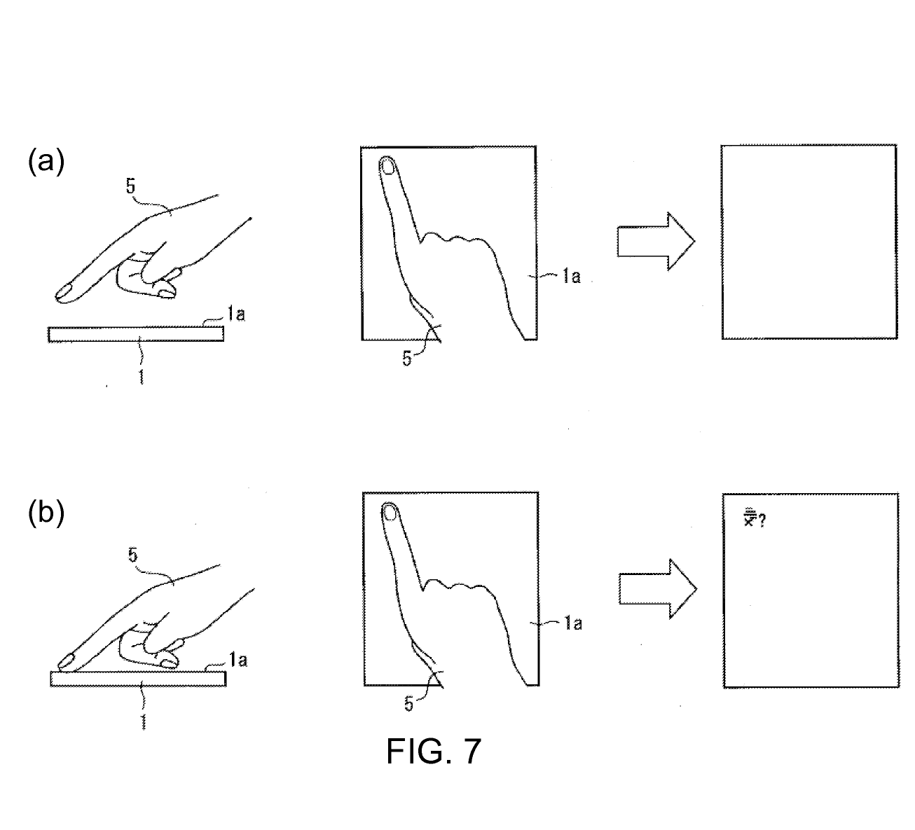

Next, Embodiment 2 of the present invention is described with reference to FIG. 7 to FIG. 10. This embodiment is different from Embodiment 1 in that the position vector (mouse cursor) 6 of the detection object 5 is displayed on the display surface 1a of the liquid crystal display panel 1 based on the positional data of the detection object 5 obtained from the light sensor and the positional data of the detection object 5 obtained from the touch sensor when the detection object 5 touches the display surface 1a of the liquid crystal display panel 1 with a pressure lower than the prescribed value. Other than that, the configuration of this embodiment is the same as Embodiment 1, which is described above. For simplicity, same reference characters are used for members having the same functions as members shown in figures of Embodiment 1, and the descriptions of those members are omitted.

FIG. 7 is for describing how accurately the location of the detection object 5 is determined by the touch sensor.

FIG. 7(a) shows a sensing image when the detection object 5 is not touching the display surface 1a of the liquid crystal display panel 1, and FIG. 7(b) shows a sensing image when the detection object 5 is touching the display surface 1a of the liquid crystal display panel 1.

As shown in FIG. 7(a), when the detection object 5 is not touching the display surface 1a of the liquid crystal display panel 1, the sensing image is blank.

As shown in FIG. 7(b), when the detection object 5 is touching the display surface 1a of the liquid crystal display panel 1, the portion of the detection object 5 that is touching the display surface 1a of the liquid crystal display panel 1 appears in the sensing image to some extent. However, in border regions of the display surface 1a of the liquid crystal display panel 1 or the like where the sealing member is disposed, the location is determined less accurately.

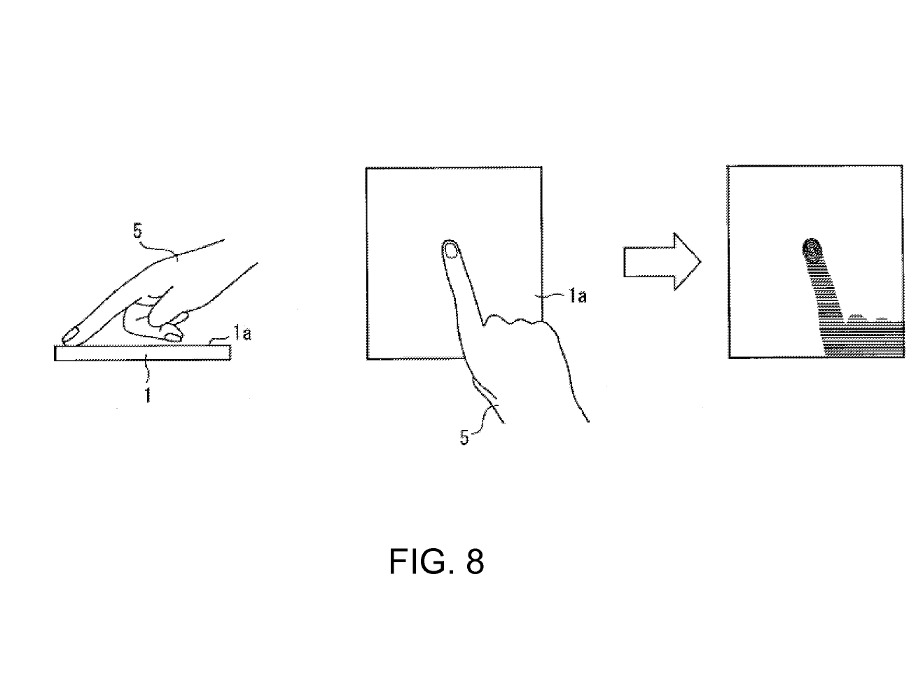

FIG. 8 is for describing how accurately the location of the detection object 5 can be detected by the light sensor and the touch sensor.

As shown in the figure, the accuracy with which the location of the detection object 5 obtained from the light sensor and the touch sensor is higher than the accuracy with which the location of the detection object 5 obtained from just one of the sensors.

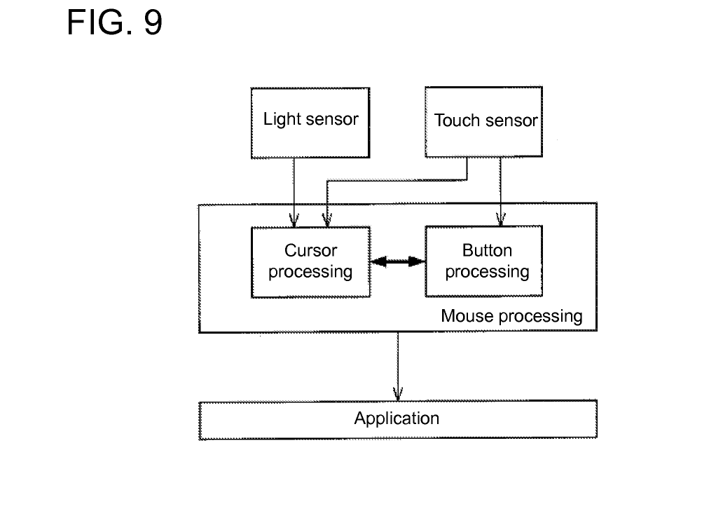

FIG. 9 is a conceptual diagram showing another example of using the light sensor function mode and the touch sensor function mode of the liquid crystal display device 30 to perform a mouse processing.

As shown in the figure, in this embodiment, based on the positional data of the detection object 5 obtained from the light sensor and the positional data of the detection object 5 obtained from the touch sensor when the touch pressure of the detection object 5 against the display surface 1a of the liquid crystal display panel 1 is below the prescribed value, the mouse cursor is displayed at the location on the display surface 1a of the liquid crystal display panel 1 that is corresponding to the location of the detection object 5 (cursor processing).

According to the configuration described above, a liquid crystal display device 30 that can display the location of the detection object 5 on the display surface 1a of the liquid crystal display panel 1 more accurately can be realized.

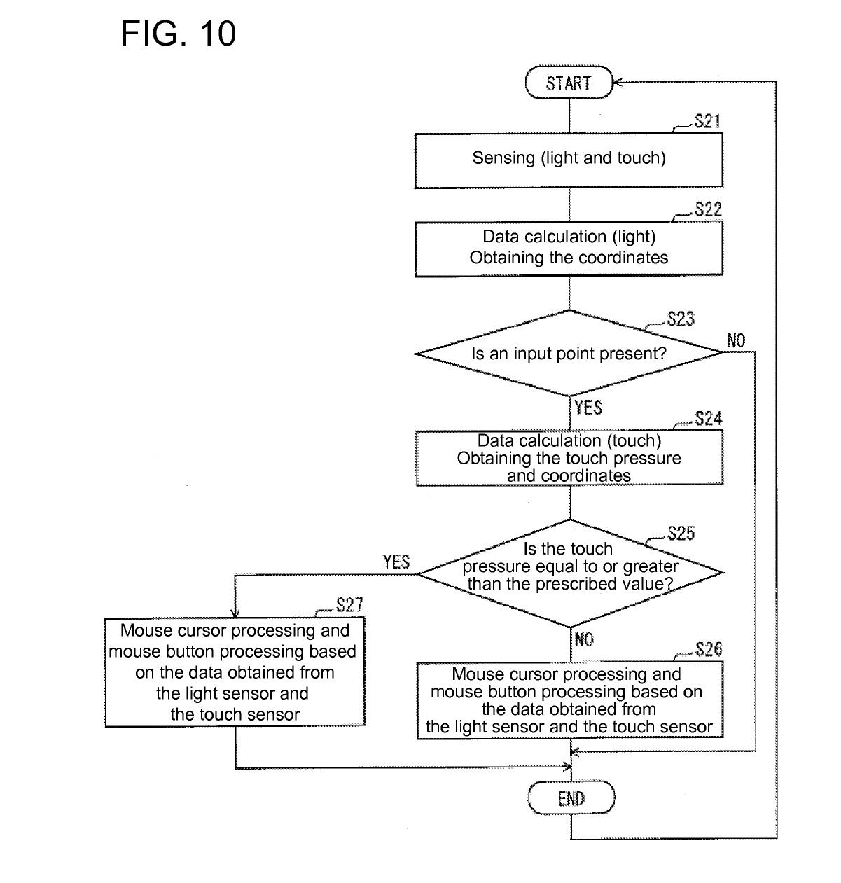

FIG. 10 is a flowchart describing another method for driving the liquid crystal display device 30.

First, in Step S21, the sensing is performed by the light sensor and the touch sensor. In Step S22, the data obtained from the light sensor is processed in the sensing image processing circuit 11 to obtain the coordinates. In Step S23, the sensing image processing circuit 11 performs calculation based on the detection result obtained from the sensor read-out circuit 10 to determine whether an input point is present or not on the display surface 1a of the liquid crystal display panel 1, and determines the presence or absence based on this calculation result. If an input point is present, the process proceeds to Step S24. If an input point is not present, the process ends at this step. When the process ends, it returns to the first step.

In Step S24, the data obtained from the touch sensor is processed in the sensing image processing circuit 11 so that data regarding the presence or absence of a touch on the display surface 1a of the liquid crystal display panel 1 and the coordinates of the touch are obtained.

In Step S25, from the data regarding the presence or absence of the touch on the display surface 1a of the liquid crystal display panel 1 obtained in Step S24, the sensing image processing circuit 11 determines whether the touch pressure is equal to or greater than the prescribed value. If the touch pressure is equal to or greater than the prescribed value, the process proceeds to Step S27, and if the touch pressure is smaller than the prescribed value, the process proceeds to Step S26.

In Step S26, the liquid crystal display panel driver circuit 4 displays the mouse cursor 6 on the display surface 1a of the liquid crystal display panel 1 based on the data regarding the location of the detection object 5 obtained from the light sensor and the touch sensor.

In Step S27, the liquid crystal display panel driver circuit 4 displays the mouse cursor 6 on the display surface 1a of the liquid crystal display panel 1 and also displays an image corresponding to the mouse cursor 6 displayed on the display surface 1a of the liquid crystal display panel 1 based on the data regarding the location of the detection object 5 obtained from the light sensor and the touch sensor.

Upon completion of Step S26 or Step S27, the process returns to the first step.

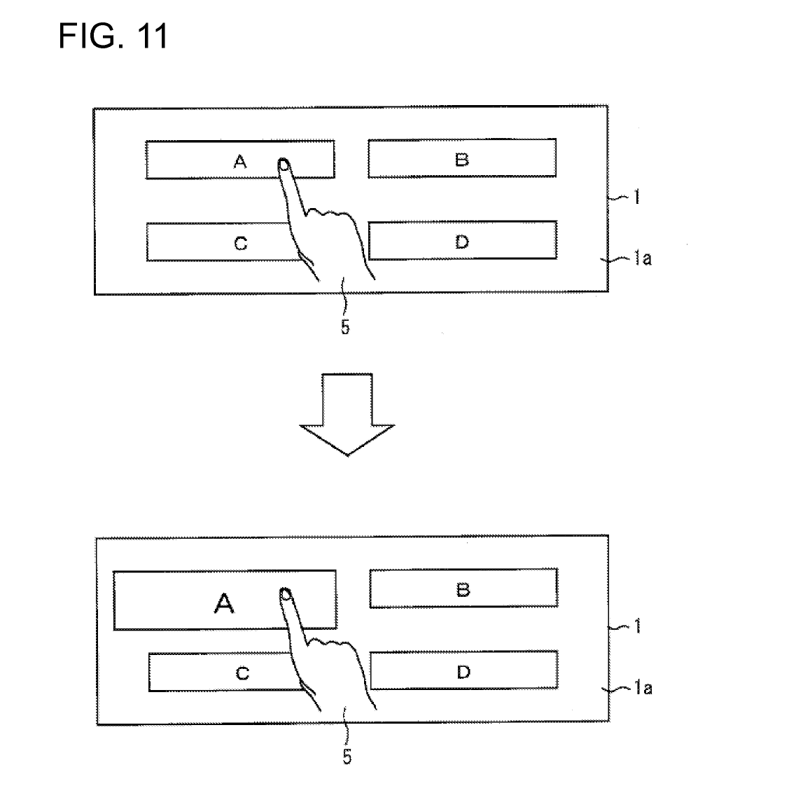

FIG. 11 shows an application example other than the mouse processing of the liquid crystal display device 30.

As shown in the figure, at the location of the detection object 5 on the display surface 1a of the liquid crystal display panel 1, a magnified view of the location of the detection object 5 may be displayed instead of the mouse cursor 6.

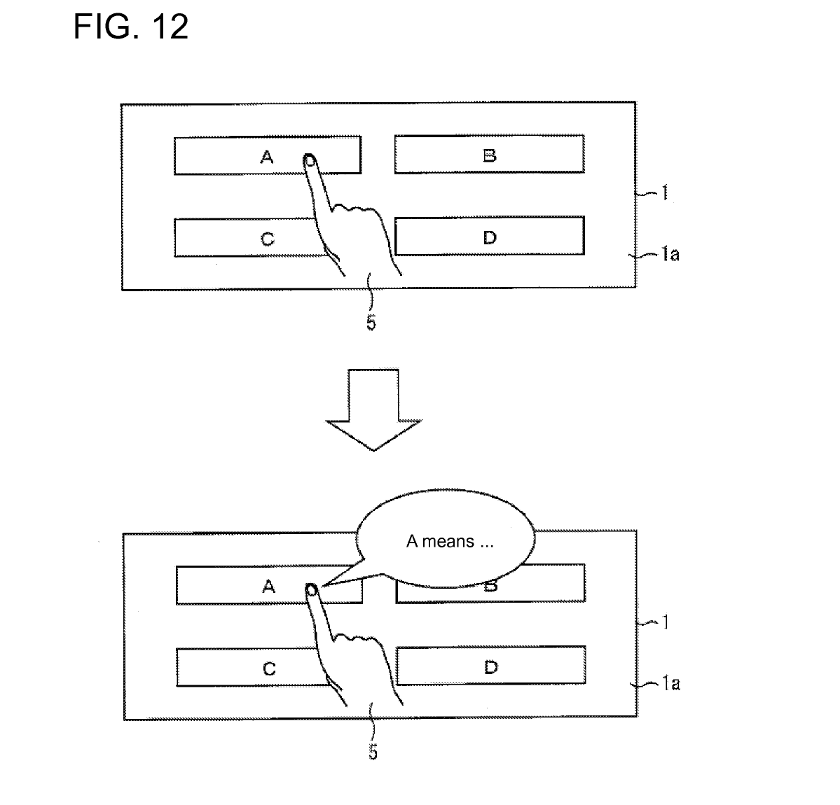

FIG. 12 shows another application example other than the mouse processing of liquid crystal display device 30.

As shown in the figure, at the location of the detection object 5 on the display surface 1a of the liquid crystal display panel 1, besides the mouse cursor 6, additional information about the location of the detection object 5, a menu, menu animation, or the like may be displayed.

Although not illustrated, at the lower left or lower right corner, for example, of the display surface 1a of the liquid crystal display panel 1, a button region such as the SHIFT key or the CTRL key on the keyboard may be provided so that, by holding down the button region with the left hand, for example, and performing a mouse operation with the right hand in the region other than this button region, a non-regular menu or the like can be displayed.

Also, by using actions that are different from the normal mouse (left) button operation, which are, for example, pressing the display surface 1a of the liquid crystal display panel 1 down for extended period of time, touching the surface with different pressures, or conducting actions such as tapping, operations that would be performed by the right mouse button or the third mouse button can be conducted.

A display device of the present invention preferably performs an input operation corresponding to the position vector of the detection object displayed on the display surface of the display panel when the touch pressure of the detection object against the display surface of the display panel is equal to or greater than the prescribed value.

In a method for driving a display device of the present invention, preferably an input operation corresponding to the position vector of the detection object on the display surface of the display panel is conducted when the touch pressure of the detection object against the display surface of the display panel is equal to or greater than the prescribed value.

According the configuration described above, only when the touch pressure of the detection object against the display surface of the display panel is equal to or greater than the prescribed value, that is, only when the detection object touches the display surface of the display panel with a pressure equal to or greater than the prescribed value, an input operation corresponding to the position vector of the detection object shown on the display surface of the display panel is conducted.

Therefore, when the detection object touches the display surface of the display panel with a pressure smaller than the prescribed value, the position vector of the detection object is displayed on the display surface of the display panel.

Thus, according to the configuration described above, a mouse cursor, for example, can be moved and displayed while the display surface of the display panel is lightly touched by the detection object with a pressure smaller than the prescribed value. The configuration, therefore, provides a display device that can determine locations with a higher accuracy and can suppress operation errors such as selection errors, as well as a method for driving the display device.

A display device of the present invention preferably displays a position vector of the detection object on the display surface of the display panel based on the positional data of the detection object obtained by the light sensor circuit and the positional data of the detection object obtained from the touch detection circuit when the touch pressure of the detection object against the display surface of the display panel is smaller than the prescribed value.

In a method for driving a display device of the present invention, the position vector of the detection object is preferably displayed on the display surface of the display panel based on the positional data of the detection object obtained from the light sensor circuit and the positional data of the detection object obtained from the touch detection circuit when the touch pressure of the detection object against the display surface of the display panel is smaller than the prescribed value.

Based on the positional data of the detection object obtained from the light sensor circuit, locations cannot be determined with a high accuracy, because a shadow is formed just by bringing the detection object, which can be a finger or a stylus pen, for example, close to the display surface of the display panel.

In the configuration described above, the position vector of the detection object is displayed on the display surface of the display panel based on the positional data of the detection object obtained from the light sensor circuit and the positional data of the detection object obtained from the touch detection circuit when the touch pressure of the detection object against the display surface of the display panel is smaller than the prescribed value.

Therefore, the configuration can provide a display device that can display the position vector of the detection object on the display surface of the display panel with a higher accuracy and a method of driving the display device.

In a display device of the present invention, the light sensor provided in the light sensor circuit and the touch sensor provided in the touch detection circuit are preferably disposed in the display panel.

According to the configuration described above, in contrast to the configuration in which a touch panel including the touch sensor is layered over the display surface of the display panel, a display device that can suppress the reduction of its luminance, the increase in the thickness, and the rise in the manufacturing cost can be realized.

A display device of the present invention is preferably configured such that, of the image displayed on the display surface of the display device, the portion corresponding to the position vector of the detection object displayed on the display surface of the display panel is a magnified view.

According to the above configuration, the portion corresponding to the position vector of the detection object displayed on the display surface of the display panel, such as the portion where the mouse cursor is present, is shown as a magnified view. As a result, a display device that is easier to use can be realized.

A display device of the present invention is preferably configured such that, of the image displayed on the display surface of the display panel, at the portion corresponding to the position vector of the detection object displayed on the display surface of the display panel, a description regarding the corresponding portion is shown.

According to the above-mentioned configuration, the portion corresponding to the position vector of the detection object displayed on the display surface of the display panel, such as the portion where the mouse cursor is present, additional description, animation, sub-menu, or the like regarding the corresponding portion is displayed. As a result, a display device that is easier to use can be realized.

For a display device of the present invention, the above-mentioned display panel is preferably a liquid crystal panel constituted of liquid crystals sealed in between a pair of substrates.

The present invention is not limited to the embodiments described above. Any one of the embodiments may be combined with others, and various modifications can be made within the scope defined by the appended claims. That is, embodiments that can be obtained by combining technological features modified within the scope defined by the appended claims are also included in the technical scope of the present invention.

### INDUSTRIAL APPLICABILITY

The present invention can suitably be used for display devices including the light sensor circuit and the touch detection circuit.

### DESCRIPTION OF REFERENCE CHARACTERS

1 liquid crystal display panel (display panel)
1a display surface
2 light sensor circuit
3 touch detection circuit
5 detection object
6 mouse cursor (position vector of a detection object)
30 liquid crystal display device (display device)
R1 display region

1. A display device comprising:
a light sensor circuit disposed in a display region of a display panel, the light sensor circuit having a light-receiving element to determine an intensity of light projected on said light-receiving element; and
a touch detection circuit disposed in the display region of the display panel, the touch detection circuit detecting a touch on a display surface of said display panel through a displacement of said display surface in a direction of the thickness of said display panel, caused by the touch,
wherein based on positional data of a detection object detected by said light sensor circuit, a position vector of the detection object is displayed on the display surface of the display panel, and when said touch detection circuit detects a touch by the detection object on said display surface of said display panel, an input operation corresponding to the position vector of the detection object displayed on said display surface of said display panel is conducted.

2. The display device according to claim 1, wherein the input operation corresponding to the position vector of the detection object displayed on said display surface of said display panel is conducted when a touch pressure of the detection object against said display surface of said display panel is equal to or greater than a prescribed value.

3. The display device according to claim 2, wherein the position vector of the detection object is displayed on said display surface of said display panel based on the positional data of the detection object obtained from said light sensor circuit and the positional data obtained from said touch detection circuit when the touch pressure of the detection object against said display surface of said display panel is smaller than said prescribed value.

4. The display device according to claim 1, wherein a light sensor provided in said light sensor circuit and a touch sensor provided in said touch detection circuit are included in said display panel.

5. The display device according to claim 1, wherein of an image displayed on said display surface of said display panel, a portion corresponding to the position vector of the detection object displayed on said display surface of said display panel is shown as a magnified view.

6. The display device according to claim 1, wherein of the image displayed on said display surface of said display panel, a portion corresponding to the position vector of the detection object displayed on said display surface of said display panel shows a description regarding said portion.

7. The display device according to claim 1, wherein said display panel is a liquid crystal panel in which a liquid crystal is sealed between a pair of substrates.

8. A method for driving a display device that includes: a light sensor circuit disposed in a display region of a display panel, the light sensor circuit having a light-receiving element to determine an intensity of light projected on said light-receiving element; and a touch detection circuit that detects a touch on a display surface of said display panel through a displacement of said display surface in a direction of thickness of said display panel, caused by the touch,
wherein the position vector of a detection object is displayed on said display surface of said display panel based on positional data of the detection object obtained from said light sensor circuit, and an input operation corresponding to the position vector of the detection object displayed on said display surface of said display panel is conducted when a touch by the detection object on said display surface of said display panel is detected by said touch detection circuit.

9. The method for driving the display device according to claim 8, wherein the input operation corresponding to the position vector of the detection object displayed on said display surface of said display panel is conducted when a touch pressure of the detection object against said display surface of said display panel is equal to or greater than a prescribed value.

10. The method for driving a display device according to claim 9, wherein the position vector of the detection object is displayed on said display surface of said display panel based on the positional data of the detection object obtained from said light sensor circuit and the positional data of the detection object obtained from said touch detection circuit when the touch pressure of the detection object against said display surface of said display object is smaller than the prescribed value.
